(19) United States
(12) Patent Application Publication
(10) Pub. No.: US 2026/0359179 A1
(43) Pub. Date: Nov. 12, 2026

(54) PROCESSOR WITH CIRCUITRY FOR SOFTWARE TEST LIBRARIES

(71) Applicant: Texas Instruments Incorporated, Dallas, TX (US)

(72) Inventors: Harshil A. Shah, McKinney, TX (US); Anish Reghunath, Allen, TX (US); Timothy David Anderson, University Park, TX (US); Steven Claypool, Dallas, TX (US); Charan Renganathan, Dallas, TX (US)

(21) Appl. No.: 19/436,141

(22) Filed: Dec. 30, 2025

Related U.S. Application Data
(60) Provisional application No. 63/801,202, filed on May 7, 2025.

(51) Int. Cl. G06F 11/263

(52) U.S. Cl. CPC G06F 11/2635

(57) ABSTRACT

Techniques for implementing a software test library using a processor configured with test circuitry. In an example, a method includes performing, during a test mode of a processor, a set of operations with an arithmetic logic unit (ALU) of the processor to generate a set of ALU results, and writing the set of ALU results to a first register of the processor. In the example, the method further includes producing, with a second register of the processor, a first signature based on the set of ALU results, and signaling a fault based on detecting a mismatch between the first signature and a second signature.

### CROSS-REFERENCE TO RELATED APPLICATION

This application claims priority to U.S. Provisional Patent Application No. 63/801,202 titled “PROCESSOR WITH CIRCUITRY AND REGISTER FOR SOFTWARE TEST LIBRARY” and filed on May 7, 2025, which Application is hereby incorporated herein by reference in its entirety.

### TECHNICAL FIELD

This description relates to computing systems and, more particularly, to methods and apparatus for running software test libraries for processors.

### BACKGROUND

A software test library (STL) is a collection of software instructions (code) and utilities that facilitate testing of software applications. STLs can be implemented as efficient assembly language routines that test for the presence of faults when executing on processors at start up and during run-time. They can be an important tool for achieving compliance with various safety standards. An STL may use a predefined data set from memory to cause a processor to execute a set of operations. The results of the operations can be compared with expected results to determine whether or not a fault exists.

### SUMMARY

According to one example, a method comprises: performing, during a test mode of a processor, a set of operations with an arithmetic logic unit (ALU) of the processor to generate a set of ALU results; writing the set of ALU results to a first register of the processor; producing, with a second register of the processor, a first signature based on the set of ALU results; and signaling a fault based on detecting a mismatch between the first signature and a second signature.

According to another example, a processor comprises: at least one arithmetic logic unit (ALU) configurable to perform a set of test operations; a first register coupled to the ALU and configurable to store test results output by the ALU based on the set of test operations performed by the ALU; logic circuitry coupled to the at least one ALU and to the first register, the logic circuitry including at least one second register configurable to produce a first signature based on the test results from the at least one ALU; and at least one control register coupled to the logic circuitry and to the at least one ALU, and coupled to the first register.

According to another example, a device comprises: a processor including a register file, logic circuitry, and a control register; memory storing a first signature for a software test library; and compare logic coupled to the logic circuitry and to the memory. The processor is configurable to: generate test results based on executing the software test library; write the test results to the register file, and provide the test results to the logic circuitry based on a control signal from the control register; wherein the logic circuitry is configurable to produce a second signature based on the test results; and wherein the compare logic is configurable to compare the second signature to the first signature to determine whether the processor generated a fault based on executing the software test library.

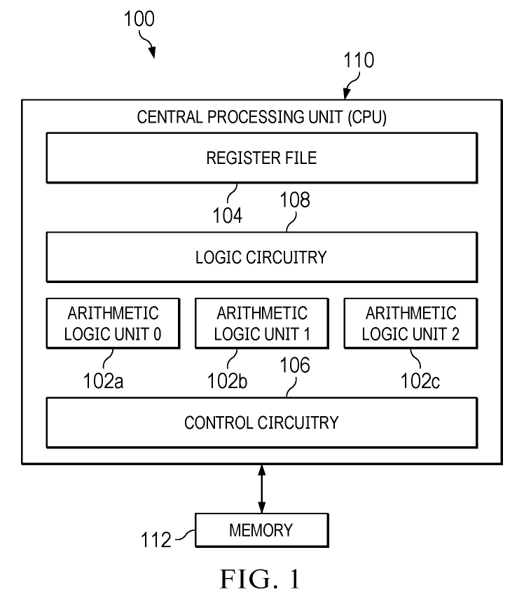

FIG. 1 is a block diagram of a system including a processor with test circuitry, according to an example.

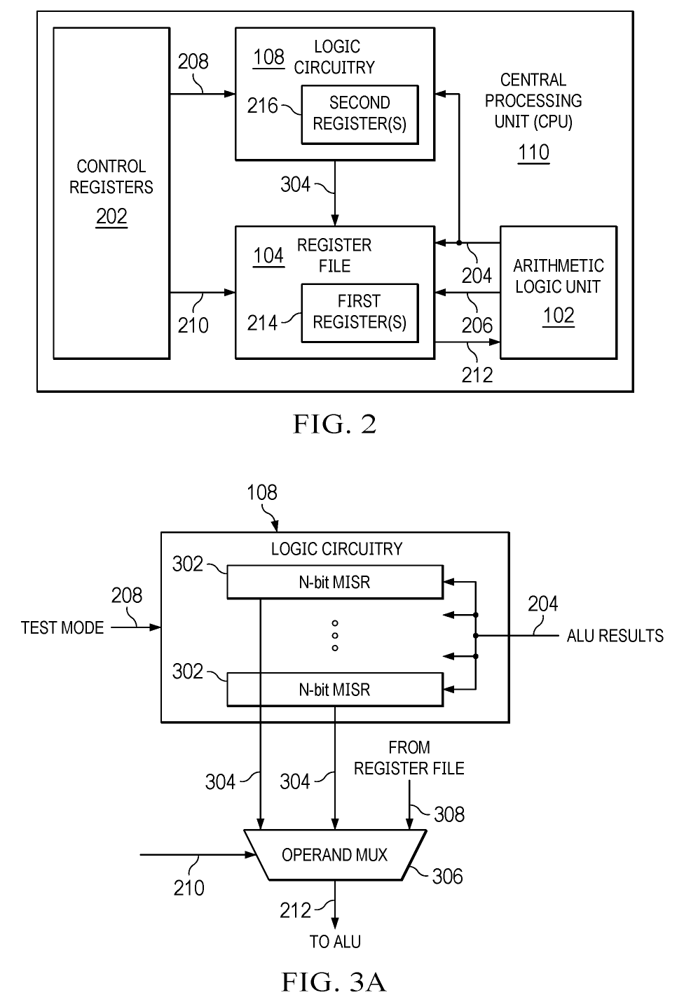

FIG. 2 is a block diagram of a processor including test circuitry, according to an example.

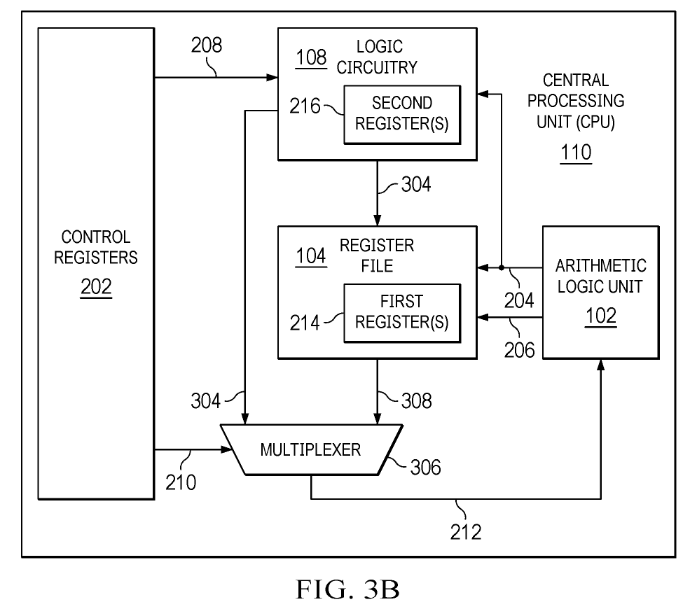

FIG. 3A is a block diagram of test circuitry, according to an example.

FIG. 3B is a block diagram of a processing including test circuitry, according to an example.

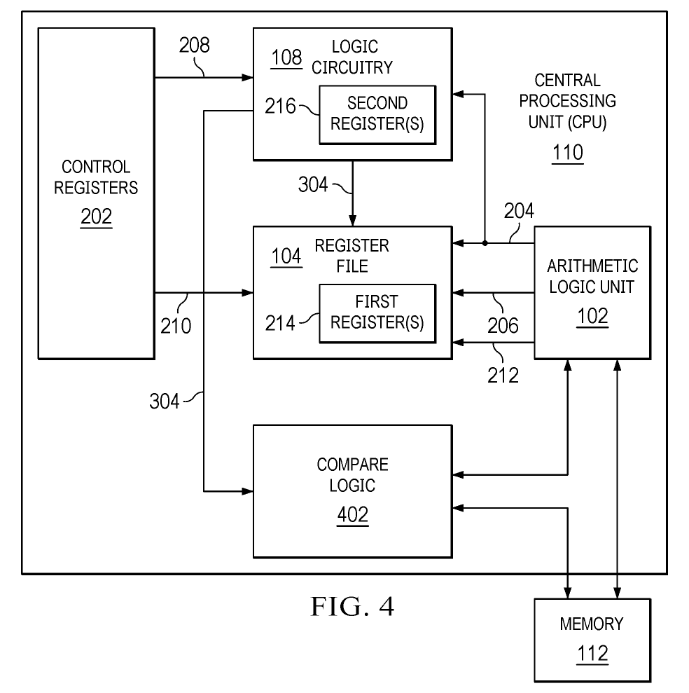

FIG. 4 is a block diagram of a system with a processor including test circuitry, according to another example.

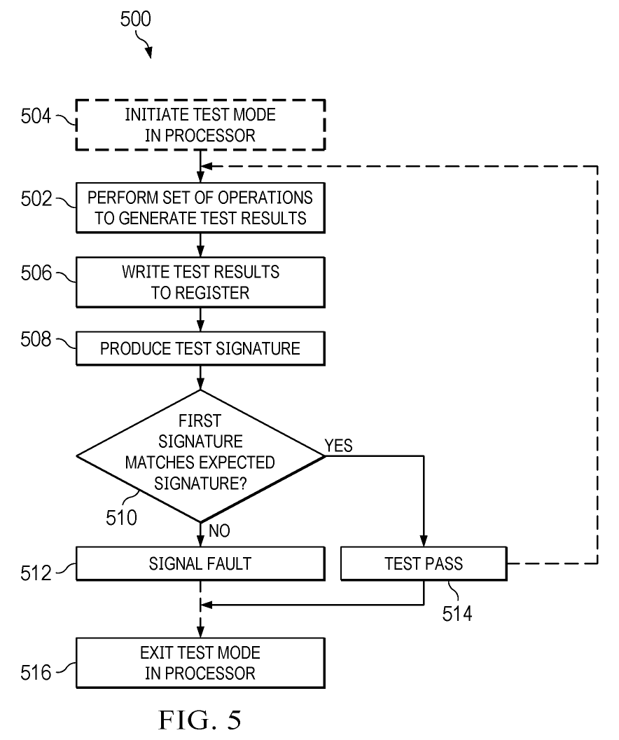

FIG. 5 is a flow diagram illustrating a method of implementing a software test library, according to an example.

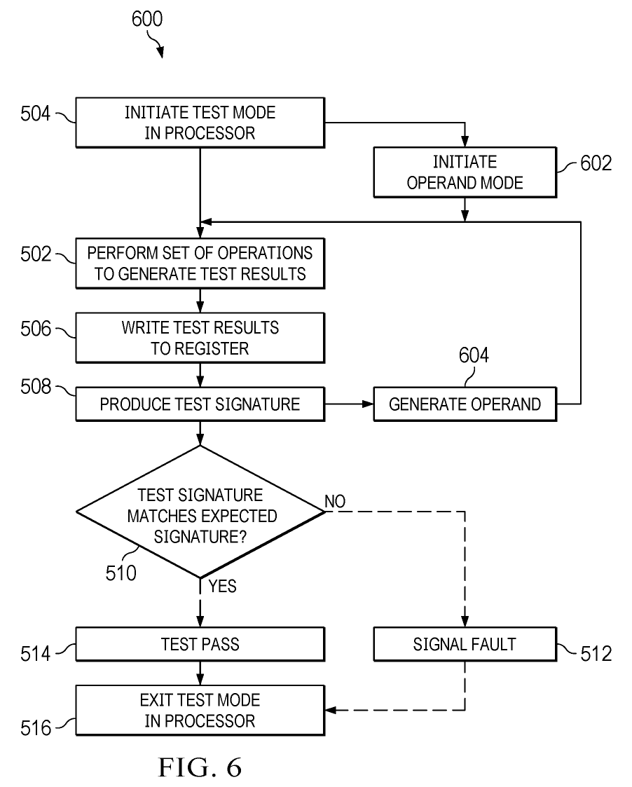

FIG. 6 is a flow diagram illustrating a method implementing a software test library, according to another example.

### DETAILED DESCRIPTION

Techniques are described for implementing a software test library using a processor configured with test circuitry. The techniques can be used, for instance, to provide a hardware-based process for producing a test signature based on running a software test library on a processor, and for using the test signature as an input operand for further testing operations. The techniques described herein advantageously may reduce the run times and software code size associated with software test libraries. According to one example, a method includes performing, during a test mode of a processor, a set of operations with an arithmetic logic unit (ALU) of the processor to generate a set of ALU results, and writing the set of ALU results to a first register of the processor. The example method further includes producing, with a second register of the processor, a first signature based on the set of ALU results; and signaling a fault based on detecting a mismatch between the first signature and a second signature.

### General Overview

As described above, software test libraries (STLs) are programs that are executed by one or more processors (e.g., central processing unit cores, digital signal processors, etc.) to detect faults. The STL program may perform a wide array of different operations to detect a wide array of different faults in the executing hardware (e.g., the processor), supporting hardware, associated peripherals, and/or other parts of a system. STLs are used for safety testing of processors and processing circuitry and, in particular, can be an important tool used to achieve compliance with various safety standards. For example, certain safety standards (e.g., ISO 26262/Automotive Safety Integrity Level) may require running one or more STLs, and a given standard may require that the STLs provide a given amount of fault detection coverage. Running a software test library (STL) may involve producing a test signature based on the processor executing a set of instructions, or operations, defined in the STL, and comparing the test signature with an expected signature to determine whether or not there is a fault in the system. In some implementations, the test signature is calculated in software after every operation and is maintained throughout the STL sequence. Calculating the software test signature may involve accumulating the results of every operation in a central processing unit (CPU) register. In another example, calculating the software test signature may involve passing the results of the operations through a software-based virtual Multiple Input Signature Register (MISR), which yields a unique signature at the end of the STL sequence. However, both of these approaches may result in significant added instructions per operation, thereby increasing the STL size (e.g., memory footprint) and run time. Additionally, in some implementations, every CPU operation in the STL uses random-valued operands for maximum coverage of the CPU logic. These operands may be preloaded in memory, which also uses up significant storage space in the memory.

To address these and other issues, examples described herein provide a hardware-based approach to producing the test signature based on STL operations. When an STL mode is activated in a CPU, signature calculation can be performed in the background (e.g., while the processor is executing the STL operations) for every register write from the processing circuitry to a register file, using logic circuitry as described below. In one example, a method includes performing, during a test mode of a processor, a set of operations with an arithmetic logic unit (ALU) of the processor to generate a set of ALU results, writing the set of ALU results to a first register of the processor, and producing, with a second register of the processor, a first signature based on the set of ALU results. In some examples, the method further includes signaling a fault (e.g., setting a fault flag) based on detecting a mismatch between the first signature and a second signature. Producing the first signature in hardware avoids the need for a software signature, thereby reducing the STL size (memory footprint) and run time. In addition, the first signature can be used to produce an input operand for the next set of operations, thereby reducing the size of the dataset for an STL. Further, because signature calculation is performed in hardware and the same signature can be used to produce an input operand, code sequences can be converted to, or used as, STLs without requiring changes to the CPU software that may otherwise be associated with producing a new STL.

These and other features are described in more detail below.

### Example System Architecture

FIG. 1 is a block diagram illustrating a system 100 according to an example. The system 100 includes a central processing unit (CPU) 110 (also referred to as a processor) and memory 112 coupled to the CPU 110. The CPU 110 may be any type of processor capable of executing instructions of a computer program. In some examples, a portion of the memory 112 may be implemented within the CPU 110. The CPU 110 includes one or more arithmetic logic units (ALUs) 102 that perform arithmetic and logic operations. In the example illustrated in FIG. 1, the CPU 110 includes three ALUs 102a, 102b, 102c. However, in other examples, the CPU 110 may include more than or fewer than three ALUs. The CPU 110 further includes a register file 104, which may include one or more first registers that may supply operands to the ALUs 102a-c and store the results of ALU operations, as described further below. The CPU 110 further includes control circuitry 106 that may orchestrate the fetching (e.g., from the memory 112), decoding, and execution of program instructions by directing the coordinated operations of the ALUs 102a-c, registers of the register file 104, and/or other components of the CPU 110. In an example, the CPU 110 further includes logic circuitry 108. The logic circuitry 108 includes circuitry configurable to produce test signatures based on the ALUs 102a-c executing operations described in one or more software test libraries.

In some examples, the logic circuitry 108 includes one or more multiple input signature registers (MISRs) that are implemented in hardware. In some examples, the logic circuitry 108 is shared across some or all ALUs 102 in the CPU 110. In some such examples, the logic circuitry 108 may include one or more hardware MISRs that are shared among some or all ALUs 102a-c, or may include one or more hardware MISRs that are dedicated to respective particular ALUs. In other examples, although not explicitly shown in FIG. 1, the CPU 110 may include multiple instances of the logic circuitry 108 that each are dedicated to one or more of the ALUs 102a-c. As described further below, one or more hardware MISRs of the logic circuitry 108 may be turned on at the start of an STL sequence and tuned off at the end of the STL sequence. Once turned on, results generated by the ALU(s) 102a, 102b, and/or 102c executing the operations of the STL may be passed to the hardware MISR(s) of the logic circuitry 108. Thus, as the ALU(s) 102a-c perform the operations indicated by the STL, the results from each operation provide or modify a value stored in the hardware MISR(s). At the end of the STL sequence, the hardware MISR(s) may produce a unique test signature, which can be compared with the expected signature for that STL (e.g., produced from simulation) to determine whether or not there is a fault in the system. Assuming that no operation encountered a fault, the resulting test signature will match the expected signature. Accordingly, the processor may provide an indication (e.g., set a flag or provide some other notification) that the STL has passed. Conversely, if the resulting signature in the MISR(s) is different from the expected signature, it can be inferred that the STL encountered a fault. As described above, the use of a hardware-generated signature avoids the need to produce a test signature in software, which may reduce the STL size and run time. Additionally, the output (test signature) from the hardware MISR(s) of the logic circuitry 108 can be used as operand(s) for further STL operations because the values may be changing randomly as the STL is executing. This avoids the need for storing operands in the memory 112. Advantageously, the logic circuitry 108 may be included in the CPU 110 having any processor architecture to improve or optimize STL run time and code size as described herein.

FIG. 2 is block diagram of the CPU 110 showing operation of the logic circuitry 108, according to an example. As shown in FIG. 2, the CPU 110 includes an ALU 102 coupled to the register file 104 and to the logic circuitry 108. The ALU 102 is a digital combinational circuit that performs arithmetic and logic operations on binary data. The register file 104 includes one or more first registers 214, which are digital storage elements (e.g., implemented using flip-flops and/or other digital logic circuitry) that store binary data in the form of bit sequences. The logic circuitry 108 includes one or more second registers 216. In some examples, the second register(s) 216 are hardware MISRs, which may be implemented using flip-flops and one or more shift registers. The CPU 110 further includes one or more control registers 202, which may be part of the control circuitry 106 of FIG. 1. The control registers 202 are coupled to the ALU 102, the logic circuitry 108, and the register file 104. When executing an STL sequence, the ALU 102 receives a test input (also referred to as an operand) and generates ALU results 204 that are written to one or more of the first registers 214 of the register file 104. In some examples, the ALU 102 may provide a register write enable signal 206 to the register file 104 to allow the ALU results 204 to the written to the first register(s) 214.

In some examples, when the ALU 102 is to execute operations corresponding to an STL, the control registers 202 may provide a control signal 208 to the logic circuitry 108 to initiate a test mode. In some examples, the test mode can be initiated by modifying at least one bit sequence stored in at least one of the control registers 202, causing the control signal 208 to be provided to the logic circuitry 108. When the test mode is active, the ALU results 204 generated by the ALU 102 and written to the register file 104 are also passed to the logic circuitry 108. FIG. 3A illustrates an example of the logic circuitry 108, which, as described above, includes a plurality of MISRs 302. Each of the MISRs 302 is a digital circuit (e.g., implemented using shift registers and/or flip-flops, for example) that can be used to provide a checksum or signature of the data that passes through it. Each MISR 302 may include an N-bit register, N being a positive integer number. Thus, the results 204 from the ALU 102 may be passed through one or more of the MISRs 302 to produce the test signature 304, as described above. Using the hardware MISRs 302 to produce the test signature 304 advantageously avoids the need for producing the test signature in software (e.g., using software-based virtual MISRs). As described above, this may may reduce the STL size and run time.

The configuration of the logic circuitry 108 may depend the number of ALUs 102 included in the CPU 110 and/or the width of the data path carrying the ALU results 204. For example, if the data path between the logic circuitry 108 and the ALU 102 is 128 bits and each MISR 302 includes a 32-bit register, the logic circuitry 108 may include four MISRs 302 per ALU 102. Thus, the results 204 from the ALU 102 may be fed along multiple “lanes” of the data path into the plurality of MISRs 302, as shown in FIG. 3, for example. In other examples, the number of MISRs 302 per ALU 102 and/or the bit number (N) of the MISRs 302 may be different. For example, if the data path between the logic circuitry 108 and the ALU 102 is 64 bits, and each MISR 302 includes a 32-bit register, the logic circuitry 108 may include two MISRs 302 per ALU 102. In another example, for a 128-bit data path and 16-bit MISRs, the logic circuitry 108 may include 8 MISRs 302 per ALU. Numerous other variations are possible. Further, as described above, MISRs 302 may be shared among multiple ALUs or the logic circuitry 108 may include a dedicated set of one or more MISRs per ALU 102. Other examples may involve numerous variations and/or other applications of the techniques described herein.

Turning to FIG. 4, as described above, the test signature 304 produced by the logic circuitry 108 may be compared to an expected signature for a given STL. In some examples, the expected signature may be stored in the memory 112. In some examples, the CPU 110 may include compare logic 402 coupled to the memory 112 and to the logic circuitry 108. The compare logic 402 may be configurable to compare the test signature 304 with the expected signature stored in the memory 112 to determine an operating status of the ALU 102 (e.g., whether or not there is a system fault). As described above, if no operation performed during execution of the STL encountered a fault, the resulting test signature 304 should match the expected signature. In such circumstances, it can be concluded that the ALU 102 is operating normally (e.g., the operating status is normal). Further, in these circumstances, the CPU 110 may provide a notification (e.g., set a flag or provide some other indication) that the STL (or test described by the STL) has passed (e.g., no fault encountered). However, if there is any difference between the test signature 304 and the expected signature (e.g., one or more corresponding bits between the two signatures are different), it can be inferred that the STL encountered a fault (e.g., the operating status of the ALU 102 is abnormal, or in fault). Accordingly, in such circumstances, the CPU 110 (e.g., the ALU 102 or the compare logic 402) may signal a fault (STL failed). In some examples, signaling a fault includes setting a fault flag. Once testing is complete (e.g., executing one or more STL sequences has been completed by the ALU 102), the processor 110 may exit the test mode. In some examples, exiting the test mode includes modifying one or more bit sequences in the control registers 202.

In some examples, the MISRs 302 of the logic circuitry 108 can be mapped to the register file 104 as a status register, thereby allowing the ALU 102 or the compare logic 402 to read back the test signature 304 and determine a pass/fail status for the STL. Thus, in some examples, the compare logic 402 may be coupled to the register file 104 to obtain the test signature 304, rather than being coupled to the logic circuitry 108 as shown in FIG. 4. In other examples, the ALU 102 may read the test signature 304 from the logic circuitry 108 or from the register file 104 and provide the test signature 304 to the compare logic 402 for comparison with the expected signature obtained from the memory 112. In some examples, the compare logic 402 may be part of the ALU 102, or may represent a compare operation performed by the ALU 102.

Referring again to FIGS. 2 and 3A, and with continuing reference to FIG. 4, as described above, in some examples, the test signature 304 produced by the logic circuitry 108 can be used as an input operand for the ALU 102. When executing an STL, the ALU 102 uses an input operand (also referred to as test input) for each operation of the STL. As described above, in some instances, the input operands can be produced using a pseudo-random number generator (or other mechanism) and stored in the memory 112. However, this approach may use up storage space in the memory 112 to store the operands. By using an intermediate test signature 304 produced after one (or more) operations of the STL to generate the input operand for the next operation(s), the need for storing numerous operands in the memory 112.

As shown in FIGS. 3A and 3B, in some examples, the CPU 110 includes an operand multiplexer 306 that may be coupled to the logic circuitry 108 and to the register file 104. In some examples, the operand multiplexer 306 may be part of the logic circuitry 108 or the register file 104 and coupled to the MISRS 302. In other examples, the multiplexer 306may be coupled to the register file 104 and the logic circuitry 108, as shown in FIG. 3B, for example. According to certain examples, the control registers 202 can initiate an operand mode by sending a mode signal 210 to activate the operand multiplexer 306. In some examples, initiating the operand mode includes modifying one or more bit sequences stored in the control registers 202 to produce the mode signal 210. When the operand mode is active, the test signature 304 from the MISRs 302 may be multiplexed, by the multiplexer 306, with an output 308 from the register file 104 to produce an input operand 212 that can be sent to the ALU 102. Accordingly, the control registers 202 may also provide the mode signal 210 to the register file 104 to cause the output 308 to be provided to the operand multiplexer 306. In some examples, the output 308 provided to the multiplexer 306 from the register file 104 includes, or is a subset of, the results 204 received from the ALU 102. The multiplexer, operating in combination with the register file 104 and the logic circuitry 108, may thus provide a hardware-based mechanism for generating input operands for STLs, thereby avoiding the need for a pseudo-random number generator and/or for storing numerous operands in the memory 112, thus saving memory storage space.

Aspects and examples described herein provide a hardware-based approach for producing test signatures, and optionally input operands, for software test libraries executing on any type of processor. The techniques described herein may be used to significantly reduce run time and/or code size of an STL. For example, using a combination of the logic circuitry 108 and operand mode described herein, the run time for some STLs may be reduced by up to about 30% and the STL code size reduced by up to about 40%. In other examples, higher software function coverage (e.g., via more operations) can be achieved with comparable run time and/or code size compared to similar STLs with lower function coverage. Furthermore, because the test signatures and optionally input operands can be produced in hardware, any program code may be seamlessly converted into an STL (by enabling the test mode via the control signal 208 and optionally the operand mode via the mode signal 210) without requiring software modifications.

### Methodology

FIG. 5 is a flow diagram of a method 500, according to one example. The method 500 may be implemented by any processor including logic circuitry 108 as described herein. In one example, the method 500 may be performed by the CPU 110.

Operation 502 includes performing a set of operations to generate a set of test results. In some examples, operation 502 is performed during a test mode of a processor. Operation 502 may include performing the set of operations with an arithmetic logic unit (ALU) of the processor to generate a set of ALU results, as described above. Performing the set of operations may correspond to executing an STL, for example.

In some examples, prior to operation 502, the method 500 includes an operation 504 of initiating the test mode. As described above, in some examples, the test mode can be initiated by modifying one or more bit sequences in the control registers 202, thereby causing the control signal 208 to be provided to the logic circuitry 108.

Operation 506 includes writing the set of test results to a first register of the processor. In some examples, the first register is at least one of the first registers 214 of the register file 104 and the test results are the ALU results 204.

Operation 508 includes producing, with a second register of the processor, a first signature based on the set of test results (e.g., the ALU results). As described above, in some examples, the second register is, or includes, at least one MISR 302 of the logic circuitry 108.

Operation 510 includes determining whether the first signature matches an expected signature. As described above, operation 510 may be performed by the compare logic 402 or the ALU 102. As described above, if the ALU 102 encounters a fault during execution of the SLT, the first signature produced at operation 508 may differ from an expected signature stored in the memory 112. In some instances, operation 510 may include determining an operating status of the ALU 102. For example, determining that the first signature does not match the second signature may include determining that the operating status of the ALU 102 is in fault (e.g., the ALU 102 has a fault status). Alternatively, determining that the first signature does match the second signature may include determining that the operating status of the ALU 102 is normal (no fault).

Accordingly, in some examples, the method 500 includes operation 512 in which a fault is signaled based on detecting a mismatch between the first signature and a second signature at operation 510. As described above, in some examples, the second signature is an expected signature for the STL. As also described above, the expected signature may be stored in the memory 112. In some examples, signaling the fault at operation 512 includes setting (e.g., by the ALU 102) a fault flag.

Alternatively, if the first signature matches the second signature, operation 514 may indicate that the test described by the SLT has passed (no fault encountered). As described above, based on the first signature matching the expected signature, it can be inferred that the ALU 102 is operating normally (e.g., the operating status of the ALU 102 is normal), and that the STL has a pass status. In some examples, at operation 514, the processor may set a flag or provide some other notification to signal that the test passed.

If testing is complete at this stage, the processor may exit the test mode at operation 516. Alternatively, if testing of the processor is not yet complete, the method 500 may return to operation 502 to perform another test (e.g., run another STL). In some examples, exiting the test mode may be achieved by modifying a bit sequence in the control registers 202 to alter the control signal 208 and instruct the circuitry to exit the test mode. Once the test mode is exited at operation 516, if a fault has not been signaled at operation 512 (e.g., no fault flag is set; or alternatively, a test pass flag is set at operation 514), the processor may be operated normally in accord with whatever application(s) the CPU is used for. In some examples, after a fault is signaled at operation 512, the test mode may be exited at operation 516; however, operation of the processor may be suspended until the fault is addressed.

FIG. 6 is a flow diagram of a method 500, according to another example. The method 600 may be a variation of the method 500, and may be performed by any processor (e.g., the CPU 110) including the logic circuitry 108 and control registers 202 described above. Thus, in some examples, the method 600 of FIG. 6 may be performed as part of performing the method 500 of FIG. 5. In the method 600, the processor is configurable to implement the operand mode described above in which intermediate test signatures produced by the MISR(s) 302 based on operations of an STL are used to produce the input operand(s) for subsequent operations of the STL.

Accordingly, operation 602 includes initiating an operand mode. As described above, operation 602 may be performed by the control registers 202 providing the operand mode control signal 210 to the register file 104 and to the operand multiplexer 306. In some examples, modifying a bit sequence stored in the control registers 202 causes the mode control signal 210 to be provided. Operation 602 may be performed in parallel with operation 504 of initiating the test mode, or may be performed after the test mode is initiated at operation 504.

In the method 600, after the operand mode is initiated at operation 602, operations 502, 506, and 508 of the method 500 described above may be performed, as shown.

At operation 604, based on the test signature 304 produced at operation 508, an operand 212 can be produced. As described above, the operand 212 may be produced by multiplexing the test signature 304 with the output 308 (e.g., the ALU results 204 or part thereof) from the register file 104 using the operand multiplexer 306. The operand 212 may then be used as an input operand for the ALU 102 at the next iteration of operation 502, as shown in FIG. 6.

Accordingly, during the test mode and with the operand mode active, the ALU 102 may perform another set of operations at operation 502 based on the operand 212 produced at operation 604 to generate an additional set of ALU results. At operation 506, the additional set of ALU results can be written to at least one of the first registers 214 of the register file 104, as described above. Accordingly, at operation 508, the logic circuitry 108 may produce another test signature based on the additional set of ALU results produced at operation 506.

In some examples, after the test mode is initiated at operation 504 and the operand mode is initiated at operation 602, operations 502, 506, 508, and 604 can be repeated until all operations of the STL being executed have been completed by the ALU 102. Once the STL operations are complete, at operation 510, the final test signature 304 can be compared to the expected signature for the STL. As described above, the expected signature can be stored in the memory 112 and operation 512 may be performed by the ALU 102 or the compare logic 402.

As described above, depending on the result of the comparison performed at operation 510, the method 600 may proceed to operation 512 (signaling a fault) if there is a mismatch between the signatures, or to operation 514 (test pass) if the signatures match.

At operation 516, the processor may exit test mode, as described above. In some examples, exiting the test mode automatically includes disabling or existing the operand mode (if the operand mode was initiated at operation 602). In other examples, operation 516 may also include providing a control signal (e.g., the mode signal 210) to exit the operand mode, which may be accomplished in part by modifying at least one bit sequence stored in the control registers 202, as described above.

### Conclusion

Thus, aspects and examples provide a hardware-based approach for producing test signatures, and optionally input operands, during execution of software test libraries.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

In this description, unless otherwise stated, “about,” “approximately” or “substantially” preceding a parameter means being within a range of that parameter, such as +/- 10 percent of that parameter or +/- 5 percent of that parameter.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways to implement such systems, methods, apparatus, and/or articles of manufacture. When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

### Further Examples

Example 1 is a method comprising: performing, during a test mode of a processor, a set of operations with an arithmetic logic unit (ALU) of the processor to generate a set of ALU results; writing the set of ALU results to a first register of the processor; producing, with a second register of the processor, a first signature based on the set of ALU results; and signaling a fault based on detecting a mismatch between the first signature and a second signature.

Example 2 includes the method of Example 1, further comprising comparing the first signature to the second signature to determine an operating status of the ALU.

Example 3 includes the method of Example 2, wherein comparing the first signature to the second signature includes identifying the mismatch between the first signature and the second signature, and wherein determining the operating status of the ALU includes determining, based on identifying the mismatch between the first signature and the second signature, that the ALU encountered a fault during performing the set of operations.

Example 4 includes the method of one of Examples 2 or 3, further comprising outputting, from the first register, a register output based on the set of ALU results, and combining, using a multiplexer, the first signature with the register output to generate an operand.

Example 5 includes the method of Example 4, further comprising: performing, during the test mode and with the ALU, another set of operations based on the operand to generate an additional set of ALU results; writing the additional set of ALU results to the first register; and producing, with the second register, a third signature based on the additional set of ALU results.

Example 6 includes the method of one of Examples 4 o 5, further comprising initiating an operand mode of the processor by modifying at least one bit sequence stored in a control register of the processor, the control register coupled to the ALU and to the first register.

Example 7 includes the method of any one of Examples 1-6, further comprising initiating the test mode in the processor, and after performing the set of operations is complete, exiting the test mode.

Example 8 includes the method of Example 7, wherein initiating the test mode includes modifying at least one bit sequence stored in a control register of the processor, the control register coupled to the ALU and to the second register.

Example 9 includes the method of any one of Examples 1-8, wherein signaling the fault based on detecting the mismatch includes setting a fault flag.

Example 10 includes the method of any one of Examples 1-9, wherein the second register is a multi-input signature register.

Example 11 is a processor configurable to implement the method of any one of Examples 1-10.

Example 12 is a processor comprising: at least one arithmetic logic unit (ALU) configurable to perform a set of test operations; a register file including one or more first registers configurable to store test results output by the ALU based on the set of test operations performed by the ALU; logic circuitry coupled to the at least one ALU and to the register file, the logic circuitry including at least one second register configurable to produce a first signature based on the test results from the at least one ALU; and at least one control register coupled to the logic circuitry, the at least one ALU, and the register file.

Example 13 includes the processor of Example 12, wherein the at least one ALU comprises a plurality of ALUs, and wherein the logic circuitry comprises a plurality of second registers, each second register of the plurality of second registers coupled to a respective ALU of the plurality of ALUs.

Example 14 includes the processor of one of Examples 12 or 13, further comprising a multiplexer coupled to the register file and to the logic circuitry.

Example 15 includes the processor of Example 14, wherein: the logic circuitry is configurable, based on a first control signal from the at least one control register, to provide the first signature to the multiplexer; the register file is configurable, based on a second control signal from the at least one control register, to provide to the multiplexer a register output based on the test results; and the multiplexer is configurable to provide, to the ALU, an operand based on the first signature and the register output.

Example 16 includes the processor of Example 15, wherein the ALU is configurable to perform an additional set of test operations based on the operand.

Example 17 includes the processor of any one of Examples 12-16, wherein the processor is configurable to signal a fault based on a mismatch between the first signature and a second signature.

Example 18 includes the processor of Example 17, wherein to signal the fault, the ALU is configurable to set a fault flag based on the mismatch between the first signature and the second signature.

Example 19 includes the processor of any one of Examples 12-18, wherein: the at least one ALU is configurable to perform the set of test operations to generate the test results based on to an input operand; the at least one ALU is configurable to write the test results to the register file; and the logic circuitry is configurable to provide the test results to the at least one second register based on a control signal from the at least one control register.

Example 20 includes the processor of any one of Examples 12-19, wherein the at least one second register is a multi-input signature register.

Example 21 is a device comprising: a processor including a register file, a logic circuitry, and a control register; memory storing a first signature for a software test library; and compare logic coupled to the logic circuitry and to the memory; wherein the processor is configurable to generate test results based on executing the software test library, write the test results to the register file, and provide the test results to the logic circuitry based on a control signal from the control register; wherein the logic circuitry is configurable to produce a second signature based on the test results; and wherein the compare logic is configurable to compare the second signature to the first signature to determine whether the processor generated a fault based on executing the software test library.

Example 22 includes the device of Example 21, wherein: the processor further comprises a multiplexer coupled to the register file and to the logic circuitry; the logic circuitry is configurable to provide the second signature to the multiplexer based on a mode signal from the control register; and the multiplexer is configurable to generate an operand based on the second signature and a register output from the register file.

Example 23 includes the device of Example 22, wherein the processor is configurable to execute the software test library using the operand as an input for operations performed during execution of the software test library.

Example 24 includes the device of any one of Examples 21-23, wherein the processor comprises an arithmetic logic unit (ALU) coupled to the register file and the logic circuitry, the ALU configurable to perform a set of operations to execute the software test library and generate the test results.

Example 25 includes the device of Example 24, wherein the processor further comprises: a plurality of additional ALUs coupled to the register file; and wherein the logic circuitry includes a plurality of multi-input signature registers (MISRs), each MISR of the plurality of MISRs coupled to a respective additional ALU of the plurality of additional ALUs and configurable to produce a respective additional second signature based on additional test results from the respective additional ALU.

Example 26 includes the device of any one of Examples 21-25, wherein the second register is a multi-input signature register.

Modifications are possible in the described examples, and other examples are possible within the scope of the claims.

What is claimed is:

1. A method comprising:
performing, during a test mode of a processor, a set of operations with an arithmetic logic unit (ALU) of the processor to generate a set of ALU results;
writing the set of ALU results to a first register of the processor;
producing, with a second register of the processor, a first signature based on the set of ALU results; and
signaling a fault based on detecting a mismatch between the first signature and a second signature.

2. The method of claim 1, comprising:
comparing the first signature to the second signature to determine an operating status of the ALU.

3. The method of claim 2, wherein comparing the first signature to the second signature includes identifying the mismatch between the first signature and the second signature, and wherein determining the operating status of the ALU includes determining, based on identifying the mismatch between the first signature and the second signature, that the ALU encountered a fault during performing the set of operations.

4. The method of claim 2, comprising:
outputting, from the first register, a register output based on the set of ALU results; and
combining, using a multiplexer, the first signature with the register output to generate an operand.

5. The method of claim 4, comprising:
performing, during the test mode and with the ALU, another set of operations based on the operand to generate an additional set of ALU results;
writing the additional set of ALU results to the first register; and
producing, with the second register, a third signature based on the additional set of ALU results.

6. The method of claim 4, comprising:
initiating an operand mode of the processor by modifying at least one bit sequence stored in a control register of the processor, the control register coupled to the ALU and to the first register.

7. The method of claim 1, comprising:
initiating the test mode in the processor; and
after performing the set of operations is complete, exiting the test mode.

8. The method of claim 7, wherein initiating the test mode includes modifying at least one bit sequence stored in a control register of the processor, the control register coupled to the ALU and to the second register.

9. A processor comprising:
at least one arithmetic logic unit (ALU) configurable to perform a set of test operations;
a register file including one or more first registers configurable to store test results output by the ALU based on the set of test operations performed by the ALU;
logic circuitry coupled to the at least one ALU and to the register file, the logic circuitry including at least one second register configurable to produce a first signature based on the test results from the at least one ALU; and
at least one control register coupled to the logic circuitry, the at least one ALU, and the register file.

10. The processor of claim 9, wherein the at least one ALU comprises a plurality of ALUs; and
wherein the logic circuitry comprises a plurality of second registers, each second register of the plurality of second registers coupled to a respective ALU of the plurality of ALUs.

11. The processor of claim 9, further comprising:
a multiplexer coupled to the register file and to the logic circuitry.

12. The processor of claim 11, wherein:
the logic circuitry is configurable, based on a first control signal from the at least one control register, to provide the first signature to the multiplexer;
the register file is configurable, based on a second control signal from the at least one control register, to provide to the multiplexer a register output based on the test results; and
the multiplexer is configurable to provide, to the ALU, an operand based on the first signature and the register output.

13. The processor of claim 12, wherein the ALU is configurable to perform an additional set of test operations based on the operand.

14. The processor of claim 9, wherein the processor is configurable to signal a fault based on a mismatch between the first signature and a second signature.

15. The processor of claim 9, wherein:
the at least one ALU is configurable to perform the set of test operations to generate the test results based on an input operand;
the at least one ALU is configurable to write the test results to the register file; and
the logic circuitry is configurable to provide the test results to the at least one second register based on a control signal from the at least one control register.

16. A device comprising:
a processor including a register file, logic circuitry, and a control register;
memory storing a first signature for a software test library; and
compare logic coupled to the logic circuitry and to the memory;
wherein the processor is configurable to
generate test results based on executing the software test library,
write the test results to the register file, and
provide the test results to the logic circuitry based on a control signal from the control register;
wherein the logic circuitry is configurable to produce a second signature based on the test results; and
wherein the compare logic is configurable to compare the second signature to the first signature to determine whether the processor generated a fault based on executing the software test library.

17. The device of claim 16, wherein:
the processor further comprises a multiplexer coupled to the register file and to the logic circuitry;
the logic circuitry is configurable to provide the second signature to the multiplexer based on a mode signal from the control register; and
the multiplexer is configurable to generate an operand based on the second signature and a register output from the register file.

18. The device of claim 17, wherein the processor is configurable to execute the software test library using the operand as an input for operations performed during execution of the software test library.

19. The device of claim 16, wherein the processor comprises an arithmetic logic unit (ALU) coupled to the register file and to the logic circuitry, the ALU configurable to perform a set of operations to execute the software test library and generate the test results.

20. The device of claim 19, wherein the processor further comprises:
a plurality of additional ALUs coupled to the register file; and
wherein the logic circuitry includes a plurality of multi-input signature registers (MISRs), each MISR of the plurality of MISRs coupled to a respective additional ALU of the plurality of additional ALUs and configurable to produce a respective additional second signature based on additional test results from the respective additional ALU.
